(19) United States
(12) Patent Application Publication
(10) Pub. No.: US 2024/0068571 A1
(43) Pub. Date: Feb. 29, 2024

(54) SEALING RING, SEALING ARRANGEMENT AND USE OF THE SEALING RING

(71) Applicant: Carl Freudenberg KG, Weinheim (DE)

(72) Inventors: Frank LAUER, Rauenberg (DE); Maik BLUHM, Schopfheim (DE); Mark BOGGASCH, Laudenbach (DE); Christian MITSCHKAL, Wald-Michelbach (DE); Thomas KRAMER, Zotzenbach (DE); Christian KOHL, Wald-Michelbach (DE); Manuel HILLE, Darmstadt (DE)

(21) Appl. No.: 18/260,790

(22) PCT Filed: Dec. 21, 2021
(86) PCT No.: PCT/EP2021/087089

§ 371 Date: Jul. 10, 2023

(30) Foreign Application Priority Data
Jan. 12, 2021 (DE) 10 2021 100 428.4

(51) Int. Cl. F16J 15/3236; F16J 15/3284

(52) U.S. Cl. CPC F16J 15/3236; F16J 15/3284

(57) ABSTRACT

A sealing ring, including at least one sealing element having a first permeation coefficient, and at least one permeation barrier of a thermoplastic material having a second permeation coefficient, wherein the at least one sealing element and the at least one permeation barrier form a unit, and wherein the first permeation coefficient is higher than the second permeation coefficient.

### CROSS REFERENCE TO RELATED APPLICATIONS

This application is a U.S. National Phase application under 35 U.S.C. § 371 of International Application No. PCT/EP2021/087089, filed on Dec. 21, 2021, and claims benefit to German Patent Application No. DE 10 2021 100 428.4, filed on Jan. 12, 2021. The International Application was published in German on Jul. 21, 2022 as WO 2022/152527 A1 under PCT Article 21(2).

### FIELD

The invention relates to a sealing ring and its use.

### BACKGROUND

Sealing rings are generally known and are used, for example, to seal off gaseous media.

Sealing action can be of the static or dynamic type. The gaseous medium to be sealed off can be pressurized.

To seal off gaseous media, O-rings or X-rings have been used, for example, which during their intended use, are sealingly arranged in an installation space of a sealing assembly while being elastically biased. The above-mentioned sealing rings automatically perform their sealing function when the elastic bias is higher than the pressure to be sealed off.

The prior-art sealing rings consist, for example, of an ethylene propylene diene rubber (EPDM rubber) or of Chlorobutyl (CIIR).

Sealing of media having low molecular weight by means of sealing rings, in particular, of the above-mentioned materials, is less than satisfactory because the above-mentioned materials have a relatively high permeation coefficient. The permeation coefficient indicates the permeability, in the present case, of a medium to be sealed off by the sealing ring.

### SUMMARY

In an embodiment, the present disclosure provides a sealing ring, comprising at least one sealing element having a first permeation coefficient, and at least one permeation barrier of a thermoplastic material having a second permeation coefficient, wherein the at least one sealing element and the at least one permeation barrier form a unit, and wherein the first permeation coefficient is higher than the second permeation coefficient.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment having two permeation barriers arranged in a functional series arrangement, between which a sealing element is arranged in the radial direction;

FIG. 2 shows an embodiment, in which a sealing element extends in the radial direction on each end face, wherein a permeation barrier extends in the axial direction from one sealing element to the other;

FIG. 3 shows an embodiment, having a sealing element in the shape of a groove ring;

FIG. 4 shows an embodiment, in which two permeation barriers are used, between which a sealing element is arranged in the radial direction;

FIG. 5 shows an embodiment, in which a sealing element extending in the radial direction is arranged on each end face;

FIG. 6 shows an embodiment similar to the exemplary embodiment of FIG. 3, wherein a sealing element is used which is connected to a permeation barrier along its inner circumference;

FIG. 7 shows an embodiment, in which two sealing elements are arranged at a radial spacing from each other, wherein a permeation barrier is arranged in the gap formed by the space; and

FIG. 8 shows an embodiment similar to the exemplary embodiment of FIG. 7, wherein a sealing element, as seen in cross-section, has a rectangular shape and is enclosed by a permeation barrier in a U shape on its side facing the medium to be sealed off.

### DETAILED DESCRIPTION

In an embodiment, the present invention provides a sealing ring that is able to also reliably seal off media having a low molecular weight during a long period of use and is thus well suited to such a use.

In an embodiment, a sealing ring is provided, comprising at least one sealing element having a first permeation coefficient, and at least one permeation barrier of a thermoplastic material having a second permeation coefficient, wherein the sealing element and the permeation barrier form a unit during the intended use of the sealing ring, and wherein the first permeation coefficient is higher than the second permeation coefficient.

By functionally combining the sealing element with the permeation barrier, the sealing ring according to an embodiment of the invention also reliably seals off media having a low molecular weight, such as gaseous media, during a long period of use.

The second permeation coefficient of the permeation barrier is substantially lower than the first permeation coefficient of the sealing element. Preferably, the ratio of the first permeation coefficient to the second permeation coefficient is at least 100, further preferably 1000 to 10000, or higher.

The excellent sealing action of the sealing ring according to an embodiment of the invention is thus primarily based on the permeation barrier.

The sealing element and permeation barrier are each optimally adapted to achieve their respective objectives. This independent design of the sealing element and permeation barrier which can be adapted to their respective tasks has the advantage that no compromises need to be made regarding the usage properties of the sealing element and/or permeation barrier.

As mentioned above, the permeation barrier ensures a good sealing result of the sealing ring during long periods of use, the sealing element is well adapted to compensate manufacturing tolerances and/or microscopic roughnesses of sealing surfaces of machine elements to be sealed off by a sealing assembly.

The permeation barrier largely prevents permeation of the medium to be sealed off through the sealing element; leakages are negligible, if they occur at all.

A sealing assembly comprising the above-described sealing ring can have substantially longer maintenance intervals than a sealing assembly in which conventional O-rings or X-rings are installed as one-component rings.

For the simple and economical operation of the sealing assembly with the sealing ring according to embodiments of the present invention, this presents an exceptional advantage.

In accordance with an advantageous embodiment, it can be provided that the sealing element is essentially completely covered by the permeation barrier at least on the side of the unit facing a medium to be sealed. To achieve this, the permeation barrier can be in directly adjacent contact, or can be indirectly associated, with the sealing element, for example by means of a connecting supporting body.

The less the medium to be sealed off is directly applied to the sealing element having the relatively higher permeation coefficient, the better the sealing action of the sealing ring will be.

A sealing ring having a permeation barrier in the above-described sense has less overall permeation than a single elastomeric element. The maintenance interval of a plant can thus be extended.

The sealing element preferably consists of an elastic rubber sealing material. Herein, it is advantageous that elastomeric sealing materials are often available at low cost and in a wide range of specifications and that the elastomeric sealing material provides excellent compensation for the manufacturing tolerances of the sealing ring and/or of the installation space and/or the surface roughness of sealing surfaces limiting the installation space. The sealing element is arranged within the installation space under elastic bias during its intended use.

The permeation barrier can be of a thermoplastic material, particularly preferably of an EVOH material. EVOH is an ethylene-vinyl alcohol copolymer.

Barrier layers of EVOH are already known. For heating applications and drinking water installations, plastic tubes can be provided with EVOH barrier layers to prevent the permeation of oxygen.

In the packaging of foodstuffs, EVOH barrier layers are used in the form of composite sheets.

To prevent permeation of a medium to be sealed off through the sealing element of the sealing ring according to embodiments of the invention, the permeation barrier is provided. This allows the sealing ring to continually have good usage properties during a long period of use. Maintenance intervals of plants comprising sealing assemblies in which such a sealing ring is used, can thus be substantially extended. This allows easy and economical operation of the sealing assembly.

The permeation barrier can be connected to a supporting body. In such a case, the supporting body connects the permeation barrier to the sealing element in an indirect manner. The permeation barrier can be integrated with the supporting body. For example, the permeation barrier is integrally connected to the supporting body.

The supporting body can be of a plastic material. Polyethylene can be used as a material, for example. In the present application, this material has the advantage that bonding to the permeation barrier and the sealing element shows particularly good sealing action and durability. Moreover, it is advantageous that polyethylene is cost-effectively available and exhibits good sealing action with respect to fluids having low molecular weights. Moreover, polyethylene can be radiation crosslinked thus ensuring little setting behavior.

The supporting body can be formed as a molded part. Such a molded part can be an injection molded part, an extruded part or a turned part. Such a molded part can also be formed as a parted hose ring or tube ring. Molded parts have low manufacturing tolerances, impart high dimensional accuracy to the sealing ring and prevent gap extrusion. Moreover, large numbers can be manufactured at low cost per part.

Moreover, the molded part can have further functions, for example as a mounting aid for better positioning/centering of the sealing ring in its installation space.

According to a further embodiment, it can be provided that the permeation barrier is formed as a foil and is combined with the sealing element to form a composite. This has the advantage that such a composite can be easily and cost-effectively manufactured, in particular as it uses little material. The composite has a very compact structural size.

The sealing element, the permeation barrier and the supporting body can be combined in a pre-assembled unit in a frictional and/or interlocking manner. Such a pre-assembled unit allows assembly/disassembly into/out of the installation space of a sealing assembly in a process-reliable and simple manner. The provision of the pre-assembled unit reduces the risk of assembly errors to a minimum.

Moreover, an embodiment of the invention also relates to a sealing assembly, comprising the sealing ring described before, and two machine elements to be sealed with respect to each other, wherein the first machine element is associated with the second machine element in a spaced relationship, wherein the sealing ring is arranged in the gap formed by the space, and wherein the permeation barrier is in sealing contact with surfaces of the machine elements to be mutually sealed. The permeation barrier prevents the medium to be sealed off from escaping through the sealing element to the environment of the sealing assembly.

Furthermore, an embodiment of the invention also relates to the use of a sealing ring as described before. According to an embodiment of the invention, it is provided that such a sealing ring is used as a hybrid protective gas seal.

In particular, for reliable sealing off a protective gas during long periods of use of the sealing ring, the permeation barrier is necessary to prevent leakages as much as possible. The permeation barrier significantly extends this period since the medium to be sealed off would first have to pass through the permeation barrier before permeating through the sealing element.

Using an assembly that is suitable and appropriate for the intended application, this period can cover the entire product life cycle.

If the sealing ring were to be formed exclusively of a sealing element consisting only of an elastomeric sealing material, such as an O-ring or X-ring, gas having a low molecular weight, for example, would permeate and undesirably escape to the environment after a relatively short period of time.

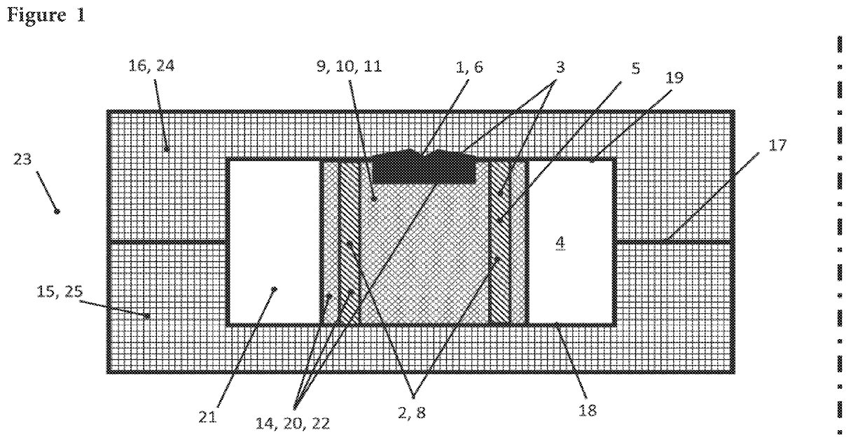

Exemplary embodiments of the sealing ring according to the invention will be shown and described in more detail in the following with reference to FIGS. 1 to 8.

In all exemplary embodiments of FIGS. 1 to 8, the sealing rings perform static sealing. All of them are hybrid protective gas seals 20. Radially inwardly from the sealing ring is the medium 4 to be sealed off, which is situated in a space 21 of a sealing assembly 22 at a relative overpressure. Radially at the side of the outer circumference, the sealing ring has atmospheric pressure applied to it from the environment 23.

The sealing ring retains the medium 4 to be sealed off, in the space 21 to be sealed off in particular by means of the permeation barrier 2 and prevents the medium 4 to be sealed off from permeating through the sealing ring to the environment 23.

The sealing ring forms a component of the sealing assembly 22. The sealing ring is used as a protective gas seal 20 in all the exemplary embodiments shown.

The sealing ring, as seen in the axial direction, is arranged between the two machine elements 15, 16, which are formed as an upper 24 and lower flange 25, and seals off the two with respect to each other.

The machine elements 15, 16 delimit a gap 17 and include the surfaces 18, 19 to be sealed off.

FIG. 1 shows a first exemplary embodiment of the sealing ring according to the invention, wherein the sealing ring comprises the sealing element 1 which consists of an elastomeric sealing material 6.

The sealing element 1 is indirectly connected to the permeation barrier 2 via the supporting body 9 consisting of a plastic material 10. The permeation barrier 2, in the exemplary embodiment shown, is formed by two rings concentrically arranged to each other, associated with each other at a radial spacing, wherein the radial space is completely filled with the plastic material 10 of the supporting body 9.

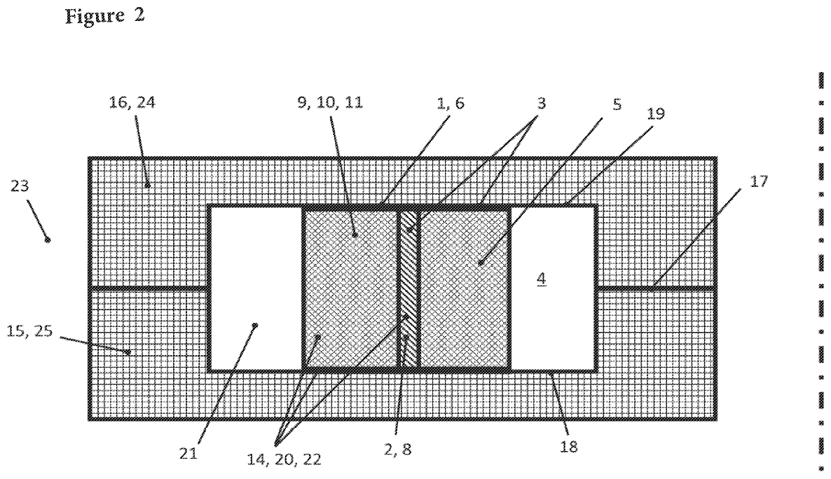

FIG. 2 shows a second exemplary embodiment, wherein the supporting body 9 is also formed as a molded part 11 like the supporting body 9 of FIG. 1 and essentially completely surrounds the permeation barrier 2 formed by a ring in FIG. 2.

A sealing element 1 extends in the radial direction on either end face of the sealing ring, wherein the sealing elements 1 are thin and flexible enough to set only in the microscopic roughnesses of the surfaces 18, 19 to be sealed off so that the permeation barrier 2 contacts the surfaces 18, 19 to be sealed off of the machine elements 15, 16 to be sealed off in an adjacent and sealing manner. The sealing elements 1 are only micrometers thick and, after installation of the sealing assembly, they have disappeared into the microscopic roughnesses of the surfaces 18, 19 to be sealed off; thereafter, the permeation barrier 2 is again in contact with the surfaces 18, 19 to be sealed off and seals them off.

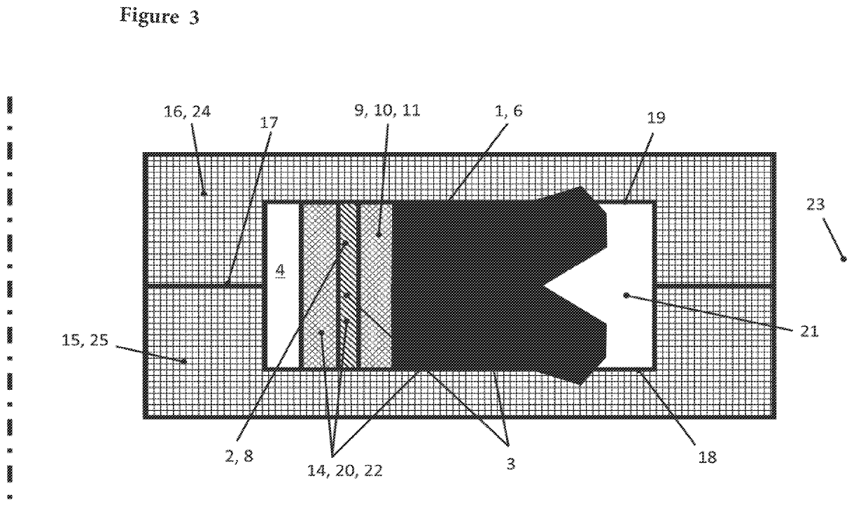

FIG. 3 shows a third exemplary embodiment, wherein the supporting body 9 is formed as a molded part 11 and, as in FIG. 2, is arranged around the permeation barrier 2.

Radially outwardly from the supporting body 9, the actual sealing element 1 is arranged which, in the exemplary embodiment shown, ensures good tolerance compensation in the axial direction.

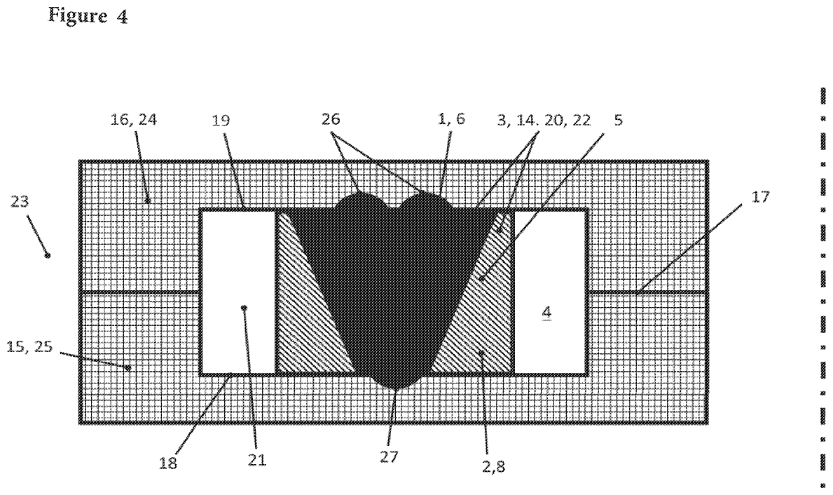

FIG. 4 shows a fourth exemplary embodiment of a sealing ring having a structural design exhibiting particular simplicity and economy of parts. The sealing ring only comprises the sealing element 1 sandwiched between two permeation barriers 2. The permeation barriers 2 are concentrically arranged and at a radial spacing in adjacent relationship, wherein the sealing element 1 is arranged in the gap formed by the space. At the one end side, the sealing element 1 includes two sealing bosses 26 annularly extending in the circumferential direction, while at the other end side it only includes one sealing boss 27. The sealing bosses 26, 27 have an influence on the contact pressure, pressure application and space filling and can be adapted in number and shape to the conditions given in each case of application, in particular to the pressure and temperature.

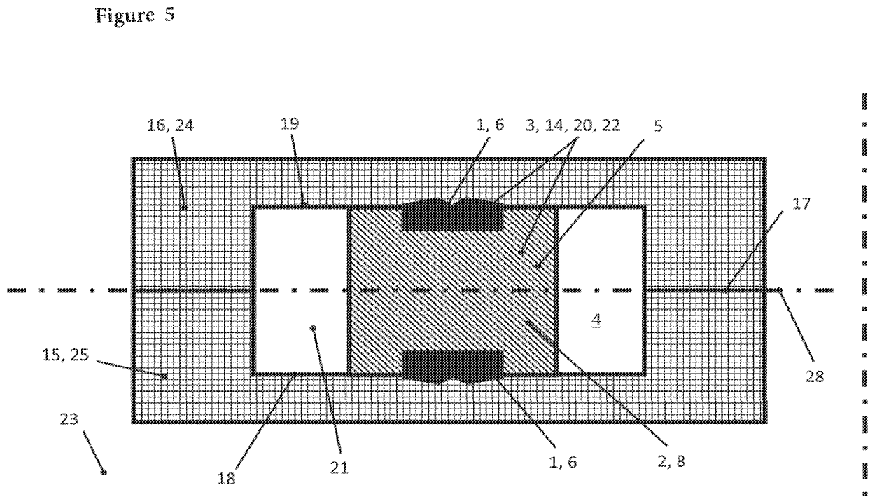

FIG. 5 shows a further exemplary embodiment of a sealing ring. The permeation barrier 2 is formed as an integral molded part and, as can be seen in the cross-section shown, has an essential H-shape. In the end-side recesses of the permeation barrier 2, on each of both end faces, a sealing element 1 is arranged, wherein the sealing elements 1 are symmetrically formed with respect to an imaginary radial plane centrally extending in the axial direction through the permeation barrier 2.

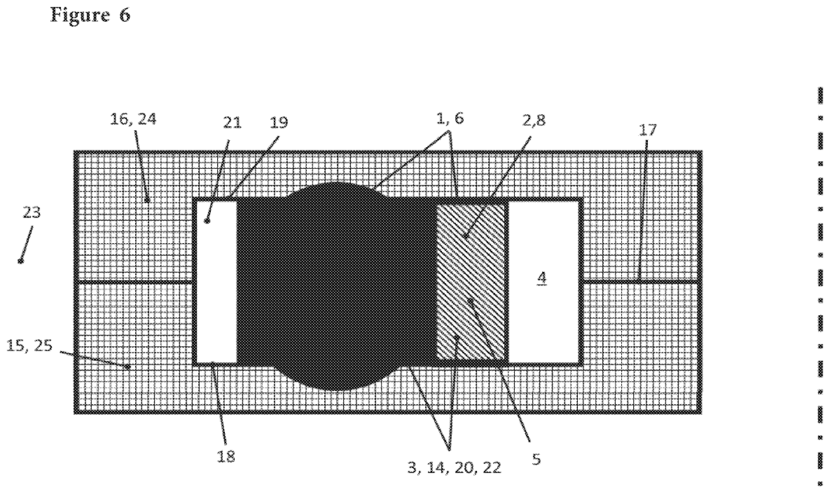

FIG. 6 shows a sixth exemplary embodiment, wherein the permeation barrier 2 is arranged radially inwardly from the sealing element 1. In a manner similar to the exemplary embodiment of FIG. 2, the sealing element is thin and flexible enough on either end face of the permeation barrier 2 to set only in the microscopic roughnesses of the surfaces 18, 19 to be sealed off so that the permeation barrier 2 contacts the surfaces 18, 19 to be sealed off of the machine elements 15, 16 to be sealed off in an adjacent and sealing manner. On either side of the permeation barrier 2, the sealing element 1 is only micrometers thick and, after installation of the sealing assembly, it has almost completely disappeared into the microscopic roughnesses of the surfaces 18, 19 to be sealed off; thereafter, the permeation barrier 2 is again in contact with the surfaces 18, 19 to be sealed off and seals them off.

In all the above-mentioned exemplary embodiments, the sealing elements 1, the permeation barriers 2, and/or the supporting bodies 9 can be connected to each other by means of interlocking and/or frictional and/or adhesive connection. The sealing element 1 and the permeation barrier 2 can thus form a unit 3. Alternatively, the sealing element 1, the permeation barrier 2 and the supporting body 9 can form the pre-assembled unit 14. Handling of the sealing ring, in particular during its installation, is thus made easier.

Interlocking connection can be achieved, for example, by the parts to be connected having recesses penetrated by the material of the respective other part. This results in particularly durable interlocking gripping of the parts with each other.

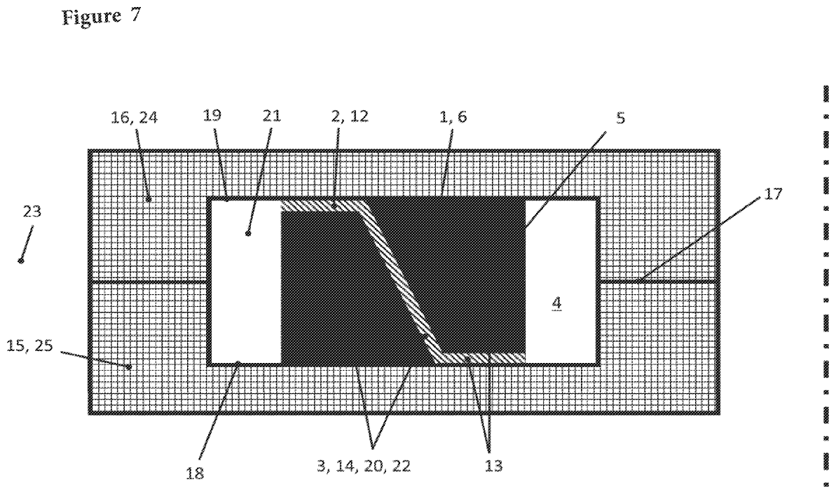

FIG. 7 shows a seventh exemplary embodiment of the sealing ring according to the invention, comprising a bipartite sealing element 1 and a permeation barrier 2 formed as a foil 12. The composite 13 comprises at least one of the parts of the sealing element 1 and the permeation barrier 2 in the form of the foil 12. The permeation barrier 2 has particularly compact dimensions so that the sealing ring also has compact dimensions overall. The composite 13 extends not only essentially in the axial direction of the sealing ring. The composite 13 extends up to the two end faces and, in the cross-section shown, essentially has a step-wise structure. This is advantageous in that, in contrast to the exemplary embodiment shown in FIG. 2, the end faces of the sealing ring are also sealed off by the permeation barrier 2.

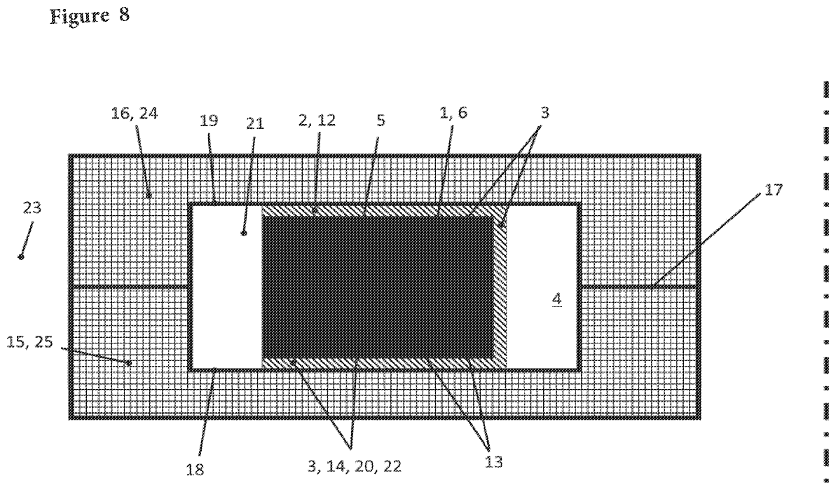

FIG. 8 shows an eighth exemplary embodiment, wherein a sealing element 1 of an elastomeric sealing material 6 is used which, together with permeation barrier 2 formed as the foil 12, forms the composite 13. The sealing element 1 is enclosed by the foil 12 in a U-shaped configuration, on the side 5 facing the medium 4 to be sealed off. The foil 12 extends along the end faces and the radially inner defining limit of the sealing element 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A sealing ring, comprising,
at least one sealing element having a first permeation coefficient; and at least one permeation barrier of a thermoplastic material having a second permeation coefficient,
wherein the at least one sealing element and the at least one permeation barrier form a unit, and
wherein the first permeation coefficient is higher than the second permeation coefficient.

2. The sealing ring according to claim 1, wherein the at least one sealing element is essentially completely covered by the at least one permeation barrier at least on a side of the unit facing a medium to be sealed.

3. The sealing ring according to claim 1, wherein the at least one the sealing element comprises a rubber-elastic sealing material.

4. The sealing ring according to claim 1, wherein the at least one permeation barrier comprises an Ethylene-vinyl alcohol copolymer (EVOH) material.

5. The sealing ring according to claim 1, wherein the at least one permeation barrier is connected to a supporting body.

6. The sealing ring according to claim 5, wherein the supporting body comprises a plastic material.

7. The sealing ring according to claim 5, wherein the at least one permeation barrier is formed as a foil and is combined with the at least one sealing element to form a composite.

8. The sealing ring according to claim 1, wherein the at least one sealing element, the at least one permeation barrier and the supporting body are combined to form a pre-assembled unit by frictional and/or interlocking or adhesive connection.

9. A sealing assembly, comprising:
the sealing ring according to claim 1; and
two machine elements to be sealed with respect to each other,
wherein a first of the two machine elements is associated with a second of the two machine elements in a spaced relationship,
wherein the sealing ring is arranged in a gap formed by the space, and
the at least one permeation barrier is in sealing contact with surfaces of the machine elements to be mutually sealed.

10. The sealing ring according to claim 1, wherein the sealing ring is configured as a hybrid protective gas seal.
